(19) United States
(12) Patent Application Publication
(10) Pub. No.: US 2026/0142856 A1
(43) Pub. Date: May 21, 2026

(54) MEMORY DEVICE DIGITAL FRONT-END INCLUDING ADJUSTED CONTINUOUS TIME LINEAR EQUALIZATION

(71) Applicant: Micron Technology, Inc., Boise, ID (US)

(72) Inventor: Gyutae Park, Boise, ID (US)

(21) Appl. No.: 19/329,911

(22) Filed: Sep. 16, 2025

Related U.S. Application Data
(60) Provisional application No. 63/722,885, filed on Nov. 20, 2024.

(51) Int. Cl. H04L 25/03

(52) U.S. Cl. CPC H04L 25/03057; H04L 25/03885

(57) ABSTRACT

This disclosure is directed to digital front-end circuitry of a memory device having widened operating frequency bandwidth. The digital front-end circuitry may include a receiver including a variable gain amplifier (VGA) and a continuous time linear equalizer (CTLE) integrated on three cascaded circuit stages. A first stage of the three cascaded circuit stages may include a first portion of the VGA and a first portion of the CTLE, a second stage may include a remaining portion of the VGA, and a third stage may include a remaining portion of the CTLE. Having three cascaded circuit stages (e.g., including the remaining portion of the CTLE) as opposed to two cascaded stages may widen the operating frequency bandwidth of the receiver. The third stage may be programmable to be activated or deactivated.

### CROSS-REFERENCE TO RELATED APPLICATION

This application claims priority to U.S. Provisional Application No. 63/722,885, filed Nov. 20, 2024, which is hereby incorporated by reference in its entirety.

### BACKGROUND

The present disclosure relates generally to digital front-end (e.g., input/output) circuitry of memory devices.

Due to the ever-increasing volume of data, data frequency and/or data speed, communication to and from memory devices is increasing. As such, a memory device may receive data for storage with increasingly higher frequencies over time. Moreover, the memory device may receive the data transmitted by an external device and delivered via a transmission channel. The transmission channel may include any viable wired or wireless medium for communicating streams of data. Increased data frequency or speed may cause distortion of data being delivered to the memory device due to real-world constraints of the transmission channel relative to the data frequency. In some cases, data received by a memory device may be distorted relative to the data transmitted by the external device. For example, the data received at digital front-end (e.g., input/output) circuitry of the memory device may be affected by inter-symbol interference (ISI) in which previously received data interferes with subsequently received data.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION OF THE DRAWINGS

Various aspects of this disclosure may be better understood upon reading the following detailed description and upon reference to the drawings described below in which like numerals refer to like parts.

FIG. 1 is a simplified block diagram illustrating certain features of a memory device, according to embodiments of the present disclosure;

FIG. 2 illustrates an input/output interface of the memory device of FIG. 1 including distortion correction circuitry, according to embodiments of the present disclosure;

FIG. 3 is a circuit diagram of a first distortion correction circuitry of FIG. 2 having three cascaded stages, according to embodiments of the present disclosure;

FIG. 4 is a circuit diagram of a programmable distortion correction circuitry of FIG. 2 having three cascaded stages, according to embodiments of the present disclosure; and

FIG. 5 is a process for operating the distortion correction circuitry of FIGS. 3 and 4, according to embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

This disclosure is directed to digital front-end circuitry of a memory device having widened operating frequency bandwidth. The digital front-end circuitry may include a receiver including a variable gain amplifier (VGA) and a continuous time linear equalizer (CTLE) integrated on three cascaded circuit stages. A first stage of the three cascaded circuit stages may include a first portion of the VGA and a first portion of the CTLE, a second stage may include a remaining portion of the VGA, and a third stage may include a remaining portion of the CTLE. Having three cascaded circuit stages (e.g., including the remaining portion of the CTLE) as opposed to two cascaded stages may widen the operating frequency bandwidth of the receiver. The third stage may be programmable to be activated or deactivated. Accordingly, the memory device may have a digital front-end circuitry with widened operating frequency bandwidth.

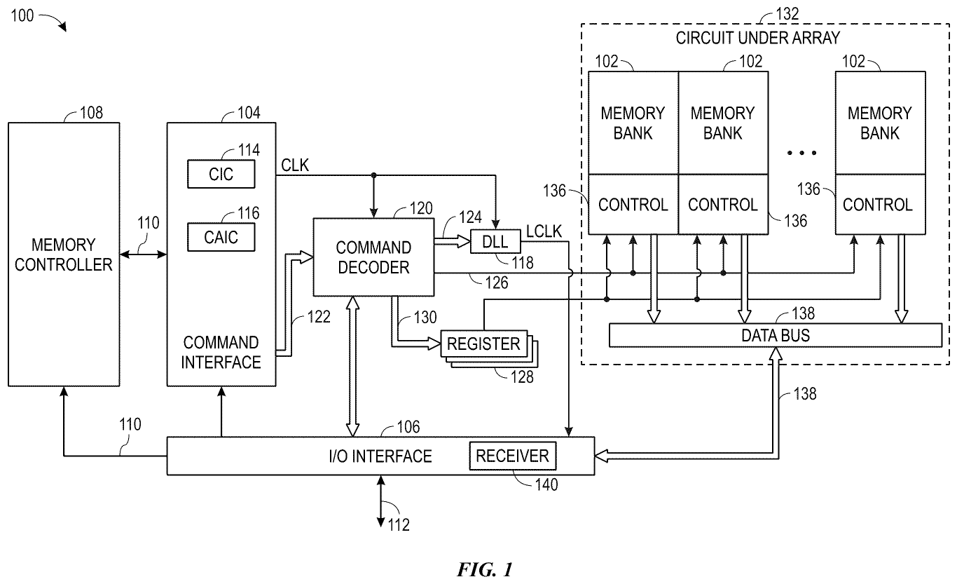

Turning now to the figures, FIG. 1 depicts a simplified block diagram illustrating certain features of a memory device 100 (e.g., a memory subsystem of an apparatus), according to embodiments of the present disclosure. Specifically, the block diagram of FIG. 1 depicts a functional block diagram illustrating certain functionality of the memory device 100. In accordance with one embodiment, the memory device 100 may include a random access memory (RAM) device, a ferroelectric RAM (FeRAM) device, a dynamic RAM (DRAM) device, a static RAM (SRAM) device (including a double data rate SRAM device), flash memory, and/or a 3D memory array including phase change (PC) memory and/or other chalcogenide-based memory, such as self-selecting memories (SSM). Moreover, each memory cell of such memory devices may include a corresponding logic storing device (e.g., a capacitor, a resistor, or the resistance of the chalcogenide material(s)).

The memory device 100 may include a number of memory banks 102 each inclusive of one or more memory arrays. For example, the memory banks 102 may be disposed in multiple columns and rows. Various configurations, organizations, and sizes of the memory banks 102 on the memory device 100 may be used based on an application and/or design of the memory device 100 within an electrical system. In different embodiments, the memory banks 102 may include a different number of rows and/or columns of memory cells. Moreover, the memory banks 102 may each communicate with other blocks of the memory device 100. As such, a number of transceivers and data lines (e.g., one or more data buses 138) may be coupled to each memory bank. For example, each memory bank 102 may receive data or data signals (e.g., data stream) from a data line and/or transceiver. In some cases, the memory banks 102 may be grouped into multiple memory groups (e.g., two memory groups, three memory groups).

The memory device 100 may also include a command interface 104 and an input/output (I/O) interface 106 (I/O circuit). The command interface 104 is configured to provide a number of signals received from a processor (e.g., a processor subsystem of an apparatus) or a controller, such as a memory controller 108. In different embodiments, the memory controller 108 may include one or more processors (e.g., memory processors), one or more programmable logic fabrics, or any other suitable processing components. In some embodiments, the memory controller 108 may represent non-transitory, computer-readable media (e.g., any suitable form of memory or storage) that may store and/or receive processor-executable code to perform at least a portion of the presently disclosed techniques. It should be noted that non-transitory merely indicates that the media is tangible and not a signal.

In some embodiments, a bus 110 (e.g., one or more buses 110) may provide a signal path or a group of signal paths to allow bidirectional communication between the memory controller 108, the command interface 104, and the I/O interface 106. For example, the memory controller 108 may receive memory access requests from the I/O interface 106 via the command interface 104 and the bus 110. Moreover, the memory controller 108 may provide the access commands and/or access instructions for performing memory operations to the command interface 104 via the bus 110. The memory operations may include transmission and receipt of data to be written to or read from the memory banks 102 (e.g., read operations, write operations).

Similarly, an external bus 112 (e.g., a data transfer bus) may provide another signal path or group of signal paths between one or more external devices (e.g., hosts, host processors, among other possibilities) and the components of the memory device 100. In some cases, an external device may include any viable type of controller and/or processor. The external bus 112 may provide the signal path or the group of signal paths to allow for bidirectional transmission of signals, such as data signals or data streams and access commands (e.g., read/write requests), between the I/O interface 106, the memory controller 108, a command decoder 120, and/or other components. In some cases, the data signals (e.g., I/O signals) may include the access commands, the data to be written to or read from the memory banks 102, among other things. Thus, in some cases, the memory controller 108 may provide various signals (e.g., the access commands, the access instructions, or other signals) to different components of the memory device 100 to facilitate the memory operations based on receiving the data signals and/or the access commands via the external bus 112.

That said, the command interface 104 may receive different signals from the memory controller 108. For example, a reset command may be used to reset the command interface 104, status registers, state machines and the like, during power-up. Various testing signals may also be provided to the memory device 100. For example, the memory controller 108 may use such testing signals to test connectivity of different components of the memory device 100. In some embodiments, the command interface 104 may also provide an alert signal to the memory controller 108 upon detection of an error in the memory device 100. Moreover, the I/O interface 106 may additionally or alternatively be used for providing such alert signals, for example, to other system components electrically connected to the memory device 100.

The command interface 104 may also receive one or more clock signals from an external device (e.g., an external clock signal). Moreover, the command interface 104 may include a clock input circuit 114 (CIC) and a command address input circuit 116 (CAIC). The command interface 104 may use the clock input circuit 114 and the command address input circuit 116 to receive the input signals, including the access commands, to facilitate communication with the memory banks 102 and other components of the memory device 100.

Moreover, the clock input circuit 114 may receive the one or more clock signals (e.g., the external clock signal) and may generate an internal clock signal (CLK) therefrom. In some embodiments, the command interface 104 may provide the CLK to the command decoder 120 and an internal clock generator, such as a delay locked loop (DLL) 118 circuit. The DLL 118 may generate a phase controlled internal clock signal (LCLK) based on the received CLK. For example, the DLL 118 may provide the LCLK to the I/O interface 106. Subsequently, the I/O interface 106 may use the received LCLK as a clock signal for transmitting the read data using the external bus 112.

The command interface 104 may also provide the internal clock signal CLK to various other memory components. As mentioned above, the command decoder 120 may receive the internal clock signal CLK. In some cases, the command decoder 120 may also receive the access commands via a bus 122 and/or through the I/O interface 106 received via the external bus 112. For example, the command decoder 120 may receive the access commands through the I/O interface 106 transmitted by one or more external devices. In some cases, a processor may transmit the access commands.

The command decoder 120 may decode the access commands and/or the memory access requests to provide corresponding access instructions for accessing target memory cells. For instance, the command decoder 120 may provide the access instructions to one or more control blocks 136 associated with the memory banks 102 via a bus 126. In some cases, the command decoder 120 may provide the access instructions to the control blocks 136 in coordination with the DLL 118 over a bus 124. For example, the command decoder 120 may coordinate generation of the access instructions in-line (e.g., synchronized) with the CLK and/or LCLK.

Accordingly, the command decoder 120 may decode the access commands (e.g., memory access requests) to provide the access instructions. In some cases, the command decoder 120 may receive the access commands using a rising edge and/or a falling edge of the external clock signal. For example, a processor may transmit the access commands using a memory command protocol such as the multi-clock cycle memory command protocol. Moreover, the processor may use a specific memory command protocol based at least in part on a number of pins of the memory device 100 or the I/O interface 106, the number of memory banks 102, the number of rows and/or columns of the memory banks 102, and/or a bandwidth of the memory device 100 for communication with one or more of the memory banks 102. Subsequently, the command decoder 120 may provide the access instructions to the memory banks 102 based on receiving and decoding the access commands. Accordingly, the command decoder 120 may provide the access instructions to the memory banks 102 using one or multiple clock cycles of the CLK via the bus 126. The command decoder 120 may also transmit various signals to one or more registers 128 via, for example, one or more wiring lines 130.

In some embodiments, the memory device 100 may include control blocks 136. In such embodiments, each memory bank 102 may be associated with or include a respective control block 136. In some cases, each of the control blocks 136 may also provide row decoding and column decoding capability based on receiving the access instructions. Accordingly, the control block 136 may facilitate accessing the memory arrays of the respective memory banks 102. For example, the control blocks 136 may include circuitry (e.g., row decoders, column decoders, transceivers, and/or data lines, among other things) to facilitate accessing the memory cells of one or more memory arrays of the respective memory banks 102 based on receiving the access instructions. Moreover, the control blocks 136 may be coupled via data buses.

In some cases, the control blocks 136 may receive the access instructions and determine target memory banks 102 associated with the target memory cells. In specific cases, the command decoder 120 may include the control circuitry 134 and/or the control blocks 136. Moreover, the control blocks 136 may also provide timing control and data control functions to facilitate execution of different commands with respect to the respective memory banks 102.

Furthermore, the memory controller 108, the command decoder 120, and/or one or more external devices may provide control signals (e.g., register commands) to the registers 128 to facilitate operations of one or more of the memory banks 102, the control circuitry 134, the control blocks 136, and the like. The registers 128 may store and/or provide instructions to configure various modes of programmable operations and/or configurations of the memory device 100. The registers 128 may include one or more mode registers 128 to define various modes of programmable operations and configurations such as a high frequency mode. The high frequency mode may increase or boost an operating frequency bandwidth of the I/O interface 106. In some cases, the I/O interface 106 may transmit and/or receive the data signals having a frequency higher than a first high threshold when the mode registers 128 store instructions indicative of the high frequency mode. For example, the memory controller 108 or one or more of the external devices (e.g., host devices, host processors) may generate the control signals (or instructions) to increase, boost, or widen an operating frequency bandwidth of the I/O interface 106 based on the mode registers 128 storing the instructions indicative of the high frequency mode.

The registers 128 may be included in various semiconductor devices to provide and/or define operations of various components of the memory device 100. In some embodiments, the registers 128 may provide configuration information to define operations of the memory device 100. For example, the registers 128 may include operation instructions for DRAMs, synchronous DRAMs, FeRAMs, chalcogenide memories (e.g., SSM memory, PC memory), or other types of memories. The registers 128 may receive various signals from the memory controller 108, the command decoder 120, the external devices, or other components, via the one or more wiring lines 130. The additional registers may involve additional wiring across the semiconductor device (e.g., die), such that the registers are communicatively coupled to the corresponding memory components.

The I/O interface 106 may include circuitry to facilitate data communication according to one or more communication standards. In some embodiments, the I/O interface 106 may include one or more I/O pads each including a number of pins (e.g., 7 pins, 10 pins, 25 pins, etc.) to facilitate data communication with external components (e.g., the processing component, such as a processor). In some cases, the I/O interface 106 may convert a data type (e.g., frequency, data rate, etc.) between the memory device 100 and one or more external devices. For example, the I/O pads may include pads associated with Low-Power Double Data Rate (LPDDR), among other possibilities.

In any case, the I/O interface 106 may receive the access commands via the pins. Moreover, data stored on the memory cells of the memory banks 102 may be transmitted to and/or retrieved from the memory banks 102 via the control blocks 136 over the data bus 138. The data bus 138 may include a plurality of bi-directional data buses to one or more external devices via the I/O interface 106. For example, the control blocks 136 may be electrically coupled via row buses and column buses of the data bus 138. In some embodiments, the data bus 138 (or the bus 126) may include a common data path, a common address path, a common write command path, and a common read command path. The data bus 138 may traverse across the memory device 100.

In some embodiments, the memory device 100 includes a circuit under array (CuA) architecture. The circuit under array 132 may include the data bus 138 for communication through the control circuitry 134 and/or between the control blocks 136. For example, the control blocks 136 may include routing circuitry including transceivers for directional communication of data over the row buses and the column buses of the data bus 138. Accordingly, the circuit under array 132 may facilitate bi-directional communication of data over the data bus 138.

The external devices (e.g., the hosts, the host processors, among other possibilities) may operate to transfer data to the memory device 100 for storage and may read data from the memory device 100 to perform various operations at the external devices. Accordingly, to facilitate these data transmissions, in some embodiments, the I/O interface 106 may include a transceiver that operates to communicate (e.g., receive and transmit) data signals with the external devices. In the depicted embodiment, the I/O interface 106 may include a receiver 140 to receive data signals from the external devices.

The receiver 140 may include amplifiers (e.g., variable gain amplifier (VGA)) and continuous time linear equalizers (CTLEs) to amplify signals during memory operations. As mentioned above, the memory controller 108 or one or more external devices may generate the control signals (or instructions) to increase, boost, or widen an operating frequency bandwidth of the I/O interface 106 higher than the first high threshold in the high frequency mode. A CTLE and/or a VGA of the receiver 140 may adjust (e.g., extend) the operating frequency bandwidth of the I/O interface 106 based on the control signals, as will be appreciated.

It should be appreciated that in some embodiments, the memory device 100 may include additional or alternative components and/or may omit one or more of the components discussed above. That is, the memory device 100 may include additional or alternative components such as power supply circuits (for receiving external VDD and VSS signals), read/write amplifiers (to amplify signals during memory operations), temperature sensors (for sensing temperatures of the memory device 100), etc. Accordingly, it should be understood that the block diagram of FIG. 1 is only provided to highlight certain functional features of the memory device 100 to aid in the subsequent detailed description.

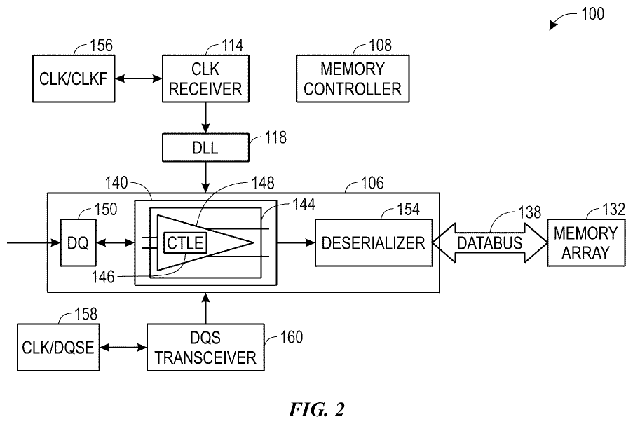

FIG. 2 illustrates the I/O interface 106 of the memory device 100 including distortion correction circuitry 144, according to embodiments of the present disclosure. The distortion correction circuitry 144 may include a CTLE 146 and a VGA 148. The I/O interface 106 may include a DQ connector 150, the receiver 140, and a deserializer 154. In the depicted embodiment, the CTLE 146 may be coupled to (e.g., integrated with) the VGA 148. It should be noted that in some embodiments, multiple I/O interfaces 106 may be utilized whereby each single I/O interface 106 may be utilized in connection with a respective portion of the data signals. Thus, the memory device 100 may include a plurality of I/O interfaces 106, each corresponding to one or more data signals (e.g., inclusive of a respective DQ connector 150, receiver 140, and deserializer 154).

The memory device 100 may receive the data signals transmitted by an external device in a serial form across the external bus 112 (e.g., a transmission channel). The external bus 112 may include any viable wired or wireless medium to facilitate communication of the data signals. The DQ connector 150 may receive the data signals. The DQ connector 150 may include any viable interface to communicate data signals, for example, for transmission of data to the circuit under array 132 as part of the data write operations. In some embodiments, the DQ connector 150 may include, for example, one or more I/O pads, a number of pins, or a combination thereof. Alternatively or additionally, the DQ connector 150 may transmit data from the circuit under array 132 as part of a data read operation.

To facilitate memory operations (e.g., the data writes), the receiver 140 is present in the I/O interface 106. In the depicted embodiment, the DQ connector 150 may transmit the data signals to the receiver 140. The receiver 140 may include the CTLE 146 and the VGA 148 to perform one or more operations on the data signals, as discussed in more details below. For example, the receiver 140 may operate as an amplifier and/or a latch for the data until reception of a respective LCLK and/or DQS signal that operates to coordinate (e.g., control) the transmission of the data to the deserializer 154.

In some embodiments, the receiver 140 may receive a clock signal generated by the DLL 118 (e.g., internal clock generator) as a timing signal for determining an input timing of the data write operations into the circuit under array 132. The clock signal transmitted by the DLL 118 may be based upon one or more clocking signals received by the memory device 100 at clock connector 156 (e.g., a pin, pad, the combination thereof, etc.) and routed to the DLL 118 via the clock input circuit 114. For example, the DLL 118 may provide the LCLK to the I/O interface 106. Thus, the receiver 140 may receive a clock signal generated by the DLL 118 as a timing signal for determining an input timing of the data write operations into the circuit under array 132. As such, the receiver 140 may perform capturing, amplification, driving, and/or latching of the data, among other possible operations, using the LCLK.

Alternatively or additionally, the receiver 140 may receive one or more DQS signals (e.g., as timing signals) to operate in a strobe data mode as part of the data write operations. The DQS signals may be received at a DQS connector 158 (e.g., a pin, pad, the combination thereof, etc.) and routed to the receiver 140 via a DQS transceiver 160 that operates to control a data strobe mode via selective transmission of the DQS signals to the receiver 140. In some embodiments, the memory device 100 may include the DQS connector 158 and/or the DQS transceiver 160. In specific embodiments, the I/O interface 106 may include the DQS connector 158 and/or the DQS transceiver 160. Thus, the receiver 140 may receive DQS signals to control the data write operations into the circuit under array 132.

As noted above, the I/O interface 106 may operate in modes to facilitate the transfers of the data to and from the memory device 100 (e.g., to and from the circuit under array 132). For example, to allow for higher data rates within the memory device 100, a data strobe mode in which DQS signals are utilized, may occur. The DQS signals may be driven by an external processor or controller sending the data (e.g., for a write command) as received by the DQS connector 158 (e.g., a pin, pad, the combination thereof, etc.). In some embodiments, the DQS signals are used as clock signals (e.g., in lieu of or in addition to the LCLK generated by the DLL 118) to capture the corresponding input data. As such, the receiver 140 may perform capturing, amplification, driving, and/or latching of the data, among other possible operations, using the DQS signals.

In any case, as mentioned above, the external bus 112 may include any viable wired or wireless medium to facilitate communication of the data signals. In some cases, if not compensated for, data transmission across the external bus 112 may cause distortion of data being delivered to the receiver 140 due to real-world constraints of the external bus 112 relative to the frequency of the data signals. For example, if not compensated for, the data received by the receiver 140 may be affected by inter-symbol interference (ISI) in which previously received data interferes with subsequently received data.

The receiver 140 may include the distortion correction circuitry 144 to reduce distortions of the data signals before providing the data signals to the deserializer 154. In particular, the receiver 140 may include the CTLE 146 to equalize the data signals by buffering or amplifying a voltage of a portion of the data signals and attenuating a remaining portion of the data signals. For example, the CTLE 146 may attenuate an undesired portion of the data signals including low frequency signals, noises, and/or interference signals to reduce ISI, among other things. Moreover, the receiver 140 may include the VGA 148 to amplify the equalized data signals. It should be appreciated that the distortion correction circuitry 144 may use the LCLK, the DQS signals, or any other viable clock or timing signals to amplify and/or equalize the data signals.

With the foregoing in mind, the CTLE 146 and the VGA 148 may receive the data signals from the DQ connector 150. In some embodiments, the data signals may be differentially provided to the CTLE 146 and the VGA 148. The CTLE 146 may equalize the data signals in a normal frequency mode or the high frequency mode. In some embodiments, the CTLE 146 may operate in the high frequency mode. In alternative or additional embodiments, the memory controller 108 discussed above or one or more of the external devices (not shown) may generate the control signals (or instructions) to select the operation mode of the CTLE 146. That is, the control signals may cause the CTLE 146 to operate in the normal frequency mode or the high frequency mode. Moreover, the CTLE 146 and the VGA 148 may adjust a gain of different signal components (e.g., a portion of) of the data signals based on a frequency of the signal components of the data signals and the selected operation mode.

For example, the CTLE 146 may cause increasing a gain of signal components of the data signals having frequencies higher than a low threshold and equal to or below a first high threshold when operating in the normal frequency mode. That is, the CTLE 146 may equalize the data signals by amplifying a portion of the data signals having a frequency within a first frequency range based on operating in the normal frequency mode. The CTLE 146 may attenuate the remaining components (e.g., remaining portion) of the data signals having frequencies below the low threshold.

Moreover, the CTLE 146 may cause increasing a gain of signal components of the data signals having frequencies higher than the low threshold and equal to or below a second high threshold when operating in the high frequency mode. As such, the CTLE 146 may equalize the data signals by amplifying a portion of the data signals having a frequency within a second frequency range based on operating in the high frequency mode. The CTLE 146 may attenuate the remaining components (e.g., remaining portion) of the data signals having frequencies below the low threshold (or a different low threshold).

The second high threshold may be higher than the first high threshold. In some cases, the low threshold may remain the same or substantially the same. As such, the second frequency range may have a wider operating frequency bandwidth compared to the first frequency range. That is, the CTLE 146 may have an extended or increased operating frequency bandwidth when operating in the high frequency mode compared to when operating in the normal frequency mode. Moreover, the memory controller 108 or the external devices may select the high frequency mode to adjust and/or extend the operating frequency bandwidth of the I/O interface 106.

The VGA 148 may amplify the equalized data signals based on a desired gain (e.g., voltage gain, current gain). As such, the receiver 140 may output the equalized and amplified data signals to the deserializer 154. The deserializer 154 may translate serial data bits (e.g., a serial bit stream) of the equalized and amplified data signals into parallel data bits (e.g., a parallel bit stream). The deserializer 154 may output the parallel data bits to the circuit under array 132 for storage via the data bus 138.

As mentioned above, the distortion correction circuitry 144 may include the CTLE 146 and the VGA 148. Moreover, the CTLE 146 may be coupled to (e.g., integrated with) the VGA 148. The distortion correction circuitry 144 and/or the VGA 148 may have three cascaded circuit stages as opposed to having two cascaded circuit stages, as will be appreciated. For example, the distortion correction circuitry 144 and/or the VGA 148 may include an additional (e.g., third) cascaded circuit stage to accommodate the additional operation mode (e.g., the high frequency mode) of the CTLE 146. Accordingly, the CTLE 146 may have an additional operation mode compared to other CTLEs. Moreover, I/O interface 106 and/or the memory device 100 may have the extended or increased operating frequency bandwidth.

It should be appreciated that in some embodiments, the I/O interface 106 may also include a transmitter and a serializer (not shown for simplicity). For example, the serializer may translate parallel data bits (e.g., a parallel bit stream) into serial data bits (e.g., a serial bit stream) during read operations of the memory device 100. As such, the deserializer operates to translate data received from, for example, the circuit under array 132 having a parallel format into a serial format suitable for transmission to an external device.

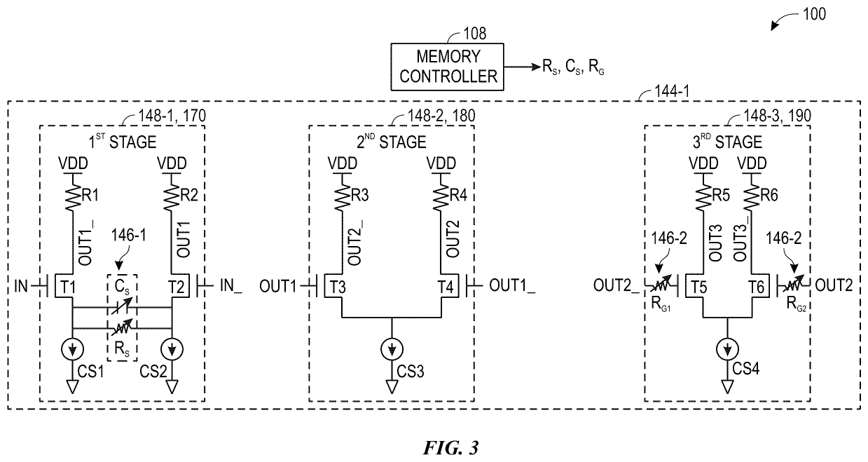

FIG. 3 is a circuit diagram of a distortion correction circuitry 144-1 of the memory device 100 having three cascaded stages 170, 180, and 190, according to embodiments of the present disclosure. The three stages 170, 180, and 190 are cascaded such that the second stage 180 may receive an output of the first stage 170, and the third stage 190 may receive an output of the second stage 180. In the depicted embodiment, the distortion correction circuitry 144-1 (e.g., the CTLE 146 and/or the VGA 148) may operate in the high frequency mode by utilizing the third stage 190. It should be appreciated that in some cases, the distortion correction circuitry 144-1 may operate in the normal frequency mode by bypassing the third stage 190.

The first stage 170 may include a first transistor T1, a second transistor T2, a first resistor R1, a second resistor R2, a first current source CS1, and a second current source CS2 forming a first portion of the VGA 148-1. The first resistor R1 and the second resistor R2 may be coupled to a supply voltage VDD. The first current source CS1 and the second current source CS2 may each include a number of switches, capacitors, and/or resistors to provide a desired current flow. The first current source CS1 and the second current source CS2 may be coupled to a ground terminal. The first transistor T1 and the second transistor T2 may differentially receive a data signal (IN and IN_).

Moreover, the first stage 170 may include a programmable capacitor C_{S} and a first programmable resistor R_{S} forming a first portion of the CTLE 146-1. The first portion of the CTLE 146-1 may be coupled to the first transistor T1 and the second transistor T2. For example, the programmable capacitor C_{S} and the first programmable resistor R_{S} may be coupled (e.g., in parallel) to a terminal (e.g., a source, a drain) of the first transistor T1 and the second transistor T2. The first portion of the VGA 148-1 and the first portion of the CTLE 146-1 may differentially generate a first output signals (OUT1 and OUT1_) by at least partially equalizing and amplifying the data signal.

The second stage 180 may include a third transistor T3, a fourth transistor T4, a third resistor R3, a fourth resistor R4, and a third current source CS3 forming a second portion of the VGA 148-2. An input (e.g., a gate) of the third transistor T3 may be coupled to a first output terminal (e.g., OUT1) of the first stage 170. An input (e.g., a gate) of the fourth transistor T4 may be coupled to a second output terminal (e.g., OUT1_) of the first stage 170. The third resistor R3 and the fourth resistor R4 may be coupled to the supply voltage VDD. The third current source CS3 may include a number of switches, capacitors, and/or resistors to provide a desired current flow. The third current source CS3 may be coupled to the ground terminal. The first transistor T1 and the second transistor T2 may differentially receive the first output signals (OUT1 and OUT1_) of the first stage 170. Moreover, the second portion of the VGA 148-2 may differentially generate second output signals (OUT2 and OUT2_) by at least partially equalizing and amplifying the data signal.

The third stage 190 may include a fifth transistor T5, a sixth transistor T6, a fifth resistor R5, a sixth resistor R6, and a fourth current source CS4 forming a third portion of the VGA 148-3. The fifth resistor R5 and the sixth resistor R6 may be coupled to the supply voltage VDD. The fourth current source CS4 may include a number of switches, capacitors, and/or resistors to provide a desired current flow. The fourth current source CS4 may be coupled to the ground terminal. The fifth transistor T5 and the sixth transistor T6 may differentially receive the second output signals (OUT2 and OUT2_) of the second stage 180.

Moreover, the third stage 190 may include a second programmable resistor R_{G1} and a third programmable resistor R_{G2} forming a second portion of the CTLE 146-2. The second programmable resistor R_{G1} may be coupled to an input (e.g., a gate) of the fifth transistor T5 and a first output terminal (e.g., OUT2_) of the second stage 180. The third programmable resistor R_{G2} may be coupled to an input (e.g., a gate) of the sixth transistor T6 and a second output terminal (e.g., OUT2) of the second stage 180. The third portion of the VGA 148-3 and the second portion of the CTLE 146-2 may differentially generate output signals (OUT3 and OUT3_) of the distortion correction circuitry 144-1 by at least partially equalizing and amplifying the data signal.

With the foregoing in mind, the CTLE 146, including the first portion of the CTLE 146-1 and the second portion of the CTLE 146-2, may attenuate signal components of the data signal having frequencies lower than the low threshold and higher than the second high threshold. As such, the VGA 148, including the first portion of the VGA 148-1, the second portion of the VGA 148-2, and the third portion of the VGA 148-3, may increase a gain of a portion (e.g., a desired portion) of the data signal having frequencies equal to or below the second high threshold and equal to or above the low threshold. That is, the CTLE 146 may cause increasing a gain of signal components of the data signals having frequencies equal to or higher than the low threshold and equal to or below the second high threshold when operating in the high frequency mode. Accordingly, in the depicted embodiment, the distortion correction circuitry 144-1 (e.g., the CTLE 146 and/or the VGA 148) may operate in the high frequency mode utilizing the three cascaded stage 170, 180, and 190.

In some embodiments, the second high threshold may be adjustable. For example, the memory controller 108 may generate the control signals to adjust the operating frequency bandwidth of the memory device 100. In the depicted embodiment, the memory controller 108 may generate the control signals to adjust a capacitance of the programmable capacitor C_{S} and/or a resistance of the programmable resistor R_{S} to adjust a first frequency response parameter (e.g., a first zero) of the distortion correction circuitry 144-1. Moreover, the memory controller 108 may generate the control signals to adjust resistances of the programmable resistors R_{G1} and/or R_{G2} to adjust a second frequency response parameter (e.g., a second zero) of the distortion correction circuitry 144-1. A resistance of the third resistor R3 and the fourth resistor R4 may provide a third frequency response parameter (e.g., a pole) of the distortion correction circuitry 144-1. As such, the memory controller 108 may adjust the second high threshold.

As mentioned above, in some cases, the distortion correction circuitry 144-1 may operate in the normal frequency mode by bypassing the third stage 190. In such cases, the first portion of the CTLE 146-1 may attenuate signal components of the data signal having frequencies lower than the low threshold and higher than the first high threshold. As such, the VGA 148, including the first portion of the VGA 148-1 and the second portion of the VGA 148-2, may increase a gain of a portion (e.g., a desired portion) of the data signal having frequencies equal to or below the first high threshold and equal to or above the low threshold. That is, the CTLE 146 may cause increasing a gain of signal components of the data signals having frequencies equal to or higher than the low threshold and equal to or below the first high threshold when operating in the high frequency mode.

The second high threshold may be higher than the first high threshold. It should be appreciated that in specific cases, the memory controller 108 may adjust the first high threshold by generating the control signals. In some embodiments, the memory controller 108 may generate the control signals by retrieving data stored in a lookup table of the memory device 100 based on the frequency of the data signal being received. The memory controller 108 may sense, determine, or receive an indication of the frequency of the data signal. Alternatively or additionally, one or more external devices (not shown) may provide the control signals to the distortion correction circuitry 144-1 and/or the memory controller 108. It should be appreciated that in alternative or additional embodiments, the programmable capacitor C_{S}, the programmable resistor R_{S}, the second programmable resistor R_{G1}, the third programmable resistor R_{G2}, or a combination thereof, may have a fixed value.

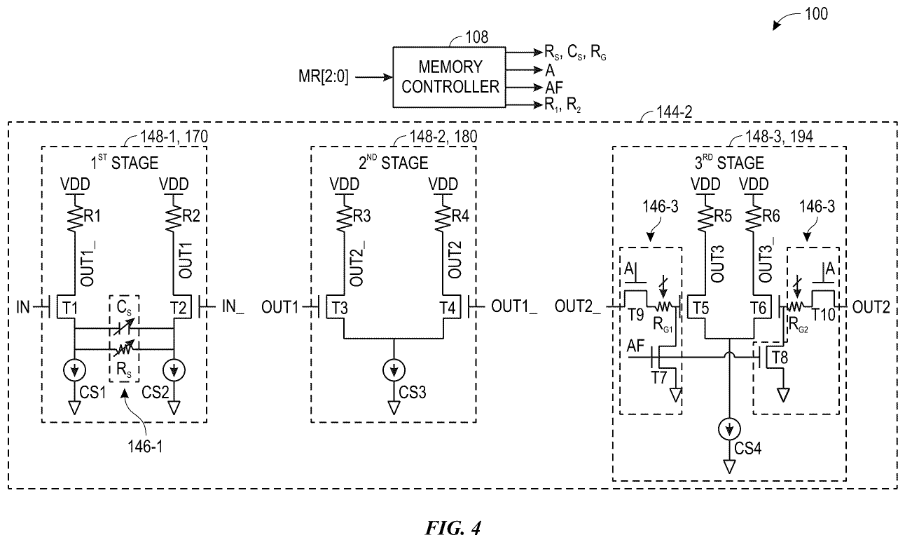

FIG. 4 is a circuit diagram of a programmable distortion correction circuitry 144-2 of the memory device 100 having three cascaded stages 170, 180, and 194, according to embodiments of the present disclosure. The three stages 170, 180, and 190 are cascaded such that the second stage 180 may receive an output of the first stage 170, and the third stage 194 may receive an output of the second stage 180. In the depicted embodiment, the programmable distortion correction circuitry 144-2 (e.g., the CTLE 146 and/or the VGA 148) may selectively operate in the normal frequency mode or the high frequency mode.

In some embodiments, the memory controller 108 or one or more of the external devices (not shown) may generate the control signals (or instructions) to select the operation mode and/or adjust the operating frequencies (e.g., the first high threshold, the second high threshold) of the CTLE 146. For example, the third stage 194 of the programmable distortion correction circuitry 144-2 may include a programmable portion of the CTLE 146-3. Moreover, the programmable distortion correction circuitry 144-2 may operate in the normal frequency mode by bypassing the third stage 194 and/or deactivating the programmable portion of the CTLE 146-3.

As discussed above, the first stage 170 may include the first transistor T1, the second transistor T2, the first resistor R1, the second resistor R2, the first current source CS1, and the second current source CS2 forming the first portion of the VGA 148-1. Moreover, the first stage 170 may include the programmable capacitor C_{S} and the first programmable resistor R_{S} forming the first portion of the CTLE 146-1. The first stage 170 may differentially generate the first output signals (OUT1 and OUT1_) by at least partially equalizing and amplifying the received data signal (IN and IN_).

The second stage 180 may include the third transistor T3, the fourth transistor T4, the third resistor R3, the fourth resistor R4, and the third current source CS3 forming a second portion of the VGA 148-2. The second stage 180 may differentially generate the second output signals (OUT2 and OUT2_) by at least partially equalizing and amplifying the first output signals (OUT1 and OUT1_) received from the first stage 170.

The third stage 194 may include the fifth transistor T5, the sixth transistor T6, the fifth resistor R5, the sixth resistor R6, and the fourth current source CS4 forming a third portion of the VGA 148-3. Moreover, the third stage 194 may include the second programmable resistor R_{G1}, the third programmable resistor R_{G2}, and transistors T7, T8, T9, and T10 forming the programmable portion of the CTLE 146-3. The second programmable resistor R_{G1} may be coupled to the input (e.g., the gate) of the fifth transistor T5 and the third programmable resistor R_{G2} may be coupled to the input (e.g., the gate) of the sixth transistor T6.

The seventh transistor T7 may be coupled to the input (e.g., the gate) of the fifth transistor T5 and the second programmable resistor R_{G1}. The eighth transistor T8 may be coupled to the input (e.g., the gate) of the sixth transistor T6 and the second programmable resistor R_{G1}. Inputs (e.g., gates) of the seventh transistor T7 and the eighth transistor T8 may receive a control signal (AF) of the memory controller 108. Moreover, the ninth transistor T9 may be coupled to the first output terminal (e.g., OUT2_) of the second stage 180 and the second programmable resistor R_{G1}. The tenth transistor T10 may be coupled to the second output terminal (e.g., OUT2) of the second stage 180 and the third programmable resistor R_{G2}. Inputs (e.g., gates) of the ninth transistor T9 and the tenth transistor T10 may receive a control signal (A) of the memory controller 108. In some cases, the control signals (A) and (AF) may be complementary or inverted.

In some cases, the third stage 194 may differentially generate output signals (OUT3 and OUT3_) of the programmable distortion correction circuitry 144-2 by at least partially equalizing and amplifying the data signal. For example, the third portion of the VGA 148-3 and the programmable portion of the CTLE 146-3 may differentially generate output signals (OUT3 and OUT3_) when activated.

As mentioned above, the memory controller 108 or one or more of the external devices (not shown) may generate the control signals to select the operation mode of the CTLE 146. In the depicted embodiment, the control signals may cause the CTLE 146 to operate in the normal frequency mode by deactivating the third stage 194 or the high frequency mode by activating the third stage 194. For example, the memory controller 108 may deactivate the third stage 194 by opening the transistors T7, T8, T9, and T10. Moreover, the memory controller 108 may activate the third stage 194 by closing the transistors T7, T8, T9, and T10.

In some embodiments, the memory controller 108 may generate the control signals by retrieving data stored in a lookup table of the memory device 100 based on the frequency of the data signal being received. For example, the memory controller 108 may activate the third stage 194 when the frequency of the data signal is higher than a frequency threshold. Moreover, the memory controller 108 may deactivate the third stage 194 when the frequency of the data signal is equal to or lower than the frequency threshold.

The CTLE 146, including the first portion of the CTLE 146-1 and the programmable portion of the CTLE 146-2, may attenuate signal components of the data signal having frequencies lower than the low threshold and higher than the second high threshold when the third stage 194 is activated. As such, the VGA 148, including the first portion of the VGA 148-1, the second portion of the VGA 148-2, and the third portion of the VGA 148-3, may increase a gain of a portion (e.g., a desired portion) of the data signal having frequencies equal to or below the second high threshold and equal to or above the low threshold. That is, the CTLE 146 may cause increasing a gain of signal components of the data signals having frequencies equal to or higher than the low threshold and equal to or below the second high threshold when operating in the high frequency mode.

Moreover, the CTLE 146, including the first portion of the CTLE 146-1 and the programmable portion of the CTLE 146-2, may attenuate signal components of the data signal having frequencies lower than the low threshold and higher than the first high threshold when the third stage 194 is deactivated. For example, the third stage 194 may be bypassed when deactivated. As such, the VGA 148, including the first portion of the VGA 148-1, the second portion of the VGA 148-2, and the third portion of the VGA 148-3, may increase a gain of a portion (e.g., a desired portion) of the data signal having frequencies equal to or below the first high threshold and equal to or above the low threshold. That is, the CTLE 146 may cause increasing a gain of signal components of the data signals having frequencies equal to or higher than the low threshold and equal to or below the first high threshold when operating in the normal frequency mode.

The memory controller 108 may adjust the first high threshold and the second high threshold, and therefore the operating frequency bandwidth of the memory device 100, by generating the control signals. As mentioned above, the memory controller 108 may generate the control signals to adjust the capacitance of the programmable capacitor C_{S} and/or the resistance of the programmable resistor R_{S} to adjust the first frequency response parameter (e.g., the first zero) of the programmable distortion correction circuitry 144-2. Moreover, the memory controller 108 may generate the control signals to adjust resistances of the programmable resistors R_{G1} and/or R_{G2} to adjust the second frequency response parameter (e.g., the second zero) of the programmable distortion correction circuitry 144-2. Furthermore, the resistance of the third resistor R3 and the fourth resistor R4 may provide the third frequency response parameter (e.g., a pole) of the programmable distortion correction circuitry 144-2. As such, the memory controller 108 may adjust the first high threshold and/or the second high threshold associated with a bandwidth of the programmable distortion correction circuitry 144-2.

The second high threshold may be higher than the first high threshold. Moreover, the thresholds (e.g., the low thresholds, the first high thresholds, the second high thresholds) of the distortion correction circuitry 144-1 of FIG. 3 and the second distortion correction circuitry 144-2 may be equal, substantially equal, or different. The memory controller 108 may sense, determine, or receive an indication of the frequency of the data signal. Alternatively or additionally, one or more external devices may provide the control signals to the programmable distortion correction circuitry 144-2 and/or the memory controller 108. It should be appreciated that in alternative or additional embodiments, the programmable capacitor C_{S}, the programmable resistor R_{S}, the second programmable resistor R_{G1}, the third programmable resistor R_{G2}, or a combination thereof, may have a fixed value.

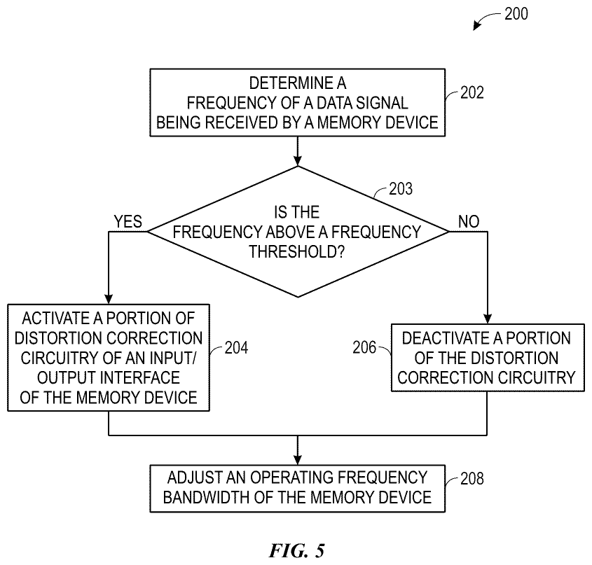

FIG. 5 is a process 200 for operating the distortion correction circuitry 144 of the memory device 100, according to embodiments of the present disclosure. The distortion correction circuitry 144 may include the distortion correction circuitry 144-1 of FIG. 3 and/or the programmable distortion correction circuitry 144-2 of FIG. 4. Although the following description of the process 200 is described with reference to the memory controller 108 of the memory device 100, it should be noted that the process 200 may be performed by one or more other external devices and/or processors disposed on other devices that may be capable of communicating with the memory device 100. Additionally, although the following process 200 describes a number of operations that may be performed, it should be noted that the process 200 may be performed in a variety of suitable orders and all of the operations may not be performed. It should be appreciated that the process 200 may be wholly executed by the memory controller 108 or the execution may be distributed between the memory controller 108 and one or more of the external devices and/or processors.

At block 202, the memory controller 108 may determine a frequency of the data signal being received by the memory device 100. For example, the I/O interface 106 may be receiving the data signal. The memory controller 108 may receive an indication of the frequency of the data signal being received, may detect and/or sense the frequency of the data signal being received, among other possibilities. In some embodiments, the memory controller 108 may determine the frequency of the data signal before receiving the data signal by the memory device 100.

At block 203, the memory controller 108 may determine whether the frequency of the data signal is above the frequency threshold. The memory controller 108 may proceed to operations of block 204 when the frequency is above the frequency threshold. At block 204, the memory controller 108 may activate the third stage 190 or 194 (e.g., a portion) of the distortion correction circuitry 144. That is, the memory controller 108 may activate a portion of the I/O interface 106. Accordingly, the I/O interface 106 may operate in the high frequency mode and increase or boost the operating frequency bandwidth of the memory device 100.

Alternatively, the memory controller 108 may proceed to operations of block 206 when the frequency is equal to or below the frequency threshold. At block 206, the memory controller 108 may deactivate the third stage 190 or 194 (e.g., the portion) of the distortion correction circuitry 144. That is, the memory controller 108 may deactivate the portion of the I/O interface 106. Accordingly, the I/O interface 106 may operate in the normal frequency mode and the memory device 100 may have a reduced operating frequency bandwidth compared to when operating in the high frequency mode.

The memory controller 108 may proceed to operations of block 208 to adjust an operating frequency bandwidth of the memory device 100. As discussed above, the memory controller 108 may generate the control signals to adjust values (e.g., resistance, capacitance) of the distortion correction circuitry 144. Accordingly, the memory controller 108 may adjust (e.g., tune) the operating frequency bandwidth of the memory device 100 when operating in the normal frequency mode and/or the high frequency mode. As such, the memory device 100 may have an increased operating frequency bandwidth based on including the distortion correction circuitry 144, including the distortion correction circuitry 144 and the VGA 148, having three cascaded circuit stages as illustrated in FIGS. 3 and 4 (as opposed to having two cascaded circuit stages).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A memory device comprising:
a memory array configured to store data; and
a receiver coupled to the memory array, wherein the receiver comprises three cascaded circuit stages forming a variable gain amplifier (VGA) and a continuous time linear equalizer (CTLE), and wherein the receiver is configured to receive a data signal comprising the data.

2. The memory device of claim 1, wherein a first portion of the CTLE is disposed on a first stage of the three cascaded circuit stages, and a remaining portion of the CTLE is disposed on a third stage of the three cascaded circuit stages.

3. The memory device of claim 1, wherein the CTLE is configured to attenuate a portion of the data signal having a frequency below a low threshold and above a high threshold.

4. The memory device of claim 1, wherein the CTLE is programmable to selectively attenuate a portion of the data signal having a frequency above a first high threshold or a second high threshold higher than the first high threshold.

5. The memory device of claim 1, wherein the CTLE is programmable to selectively have a first operating frequency bandwidth or a second operating frequency bandwidth wider than the first operating frequency bandwidth.

6. The memory device of claim 1, wherein the VGA is disposed on a first stage and a second stage of the three cascaded circuit stages.

7. The memory device of claim 1, wherein the VGA is configured to amplify the data based on a gain and an operating frequency bandwidth of the receiver.

8. The memory device of claim 1, comprising a memory controller coupled to the receiver, wherein the memory controller is configured to:
select an operating frequency bandwidth of the receiver; and
tune the selected operating frequency bandwidth.

9. The memory device of claim 8, wherein the memory controller is configured to activate and deactivate a third stage of the three cascaded circuit stages to select the operating frequency bandwidth.

10. The memory device of claim 8, wherein the memory controller is configured to adjust a resistance or a capacitance of a component of the CTLE to tune the selected operating frequency bandwidth.

11. A receiver comprising:
a connector configured to receive a data signal;
a continuous time linear equalizer (CTLE), wherein a first portion of the CTLE is disposed on a first stage of three cascaded circuit stages of the receiver, and a remaining portion of the CTLE is disposed on a third stage of the three cascaded circuit stages, wherein the first stage of the three cascaded circuit stages is coupled to the connector and is configured to receive the data signal; and
a variable gain amplifier (VGA) disposed on the first stage and a second stage of the three cascaded circuit stages, wherein the third stage of the three cascaded circuit stages is configured to output the data signal, as adjusted by the CTLE and the VGA.

12. The receiver of claim 11, wherein the CTLE is configured to attenuate a portion of the data signal having a frequency below a low threshold and above a high threshold to equalize the data signal, and the VGA is configured to amplify the data signal, as adjusted by the CTLE, based on a gain.

13. The receiver of claim 12, wherein the third stage is configured to output the data signal, as amplified by the VGA and equalized by the CTLE.

14. The receiver of claim 11, wherein the CTLE is programmable to selectively have a first operating frequency bandwidth or a second operating frequency bandwidth wider than the first operating frequency bandwidth.

15. Tangible, non-transitory, computer-readable media storing instructions that, when executed by a memory controller of a memory device, cause the memory controller to:
determine a frequency of a data signal for reception by a receiver of the memory device, wherein the receiver comprises a variable gain amplifier (VGA) and a continuous time linear equalizer (CTLE) disposed on three cascaded circuit stages;
activate a third stage of the three cascaded circuit stages to widen an operating frequency bandwidth of the receiver based on the data signal having a frequency higher than a frequency threshold; and
deactivate the third stage based on the data signal having a frequency equal to or below the frequency threshold.

16. The tangible, non-transitory, computer-readable media of claim 15, wherein a first portion of the CTLE is disposed on a first stage of the three cascaded circuit stages and a remaining portion of the CTLE is disposed on the third stage of the three cascaded circuit stages.

17. The tangible, non-transitory, computer-readable media of claim 16, wherein the instructions cause the memory controller to tune a resistance value or a capacitance value of one or more components of the CTLE disposed on the three cascaded circuit stages.

18. The tangible, non-transitory, computer-readable media of claim 17, wherein the instructions cause the memory controller to:
tune the resistance value or the capacitance value of a first component of the one or more components disposed on the first portion of the CTLE based on activating the first portion of the CTLE; and
tune the resistance value or the capacitance value of a second component of the one or more components disposed on a remaining portion of the CTLE based on deactivating the first portion of the CTLE.

19. The tangible, non-transitory, computer-readable media of claim 15, wherein the VGA is disposed on a first stage and a second stage of the three cascaded circuit stages.

20. The tangible, non-transitory, computer-readable media of claim 15, wherein the VGA is configured to amplify the data signal based on a gain and the operating frequency bandwidth.
